(19) United States
(12) Patent Application Publication
(10) Pub. No.: US 2014/0294110 A1
(43) Pub. Date: Oct. 2, 2014

(54) METHOD AND APPARATUS FOR OPPORTUNISTIC INTERFERENCE ALIGNMENT (OIA) IN MULTI-USER MULTIPLE-INPUT MULTIPLE-OUTPUT (MU-MIMO) TRANSMISSION

(71) Applicant: Electronics and Telecommunications Research Institute, Daejeon (KR)

(72) Inventors: Min Ho CHEONG, Daejeon (KR); Hyoung Jin KWON, Daejeon (KR); Jae Seung LEE, Daejeon (KR); Sok Kyu LEE, Daejeon (KR)

(73) Assignee: Electronics and Telecommunications Research Institute, Daejeon (KR)

(21) Appl. No.: 14/242,137

(22) Filed: Apr. 1, 2014

(30) Foreign Application Priority Data
Apr. 1, 2013 (KR) 10-2013-0035225
Mar. 27, 2014 (KR) 10-2014-0035951

(51) Int. Cl. H04B 1/04; H04W 52/24; H04B 7/04

(52) U.S. Cl. CPC H04B 1/0475; H04B 7/0413; H04W 52/243
USPC 375/267

(57) ABSTRACT

A method and apparatus for opportunistic interference alignment (OIA) in multi-user multiple-input multiple-output (MU-MIMO) transmission, the method including broadcasting a random beam, receiving, from a terminal, feedback information determined based on the random beam, selecting at least one terminal to which data is to be transmitted from among terminals based on the feedback information, adjusting a transmission power based on the feedback information, and transmitting data to the selected at least one terminal based on the adjusted transmission power.

### CROSS-REFERENCE TO RELATED APPLICATIONS

This application claims the benefit of Korean Patent Application No. 10-2013-0035225, filed on Apr. 1, 2013, and Korean Patent Application No. 10-2014-0035951, filed on Mar. 27, 2014, in the Korean Intellectual Property Office, the disclosures of which are incorporated herein by reference.

### BACKGROUND

1. Field of the Invention

The present invention relates to a method for opportunistic interference alignment (OIA) in a wireless local area network (WLAN) and technology for controlling a transmission power.

2. Description of the Related Art

A local area network (LAN) may be divided into a wired LAN and a wireless LAN. The wireless LAN, also referred to as WLAN, refers to a method of performing communication using radio waves in a network, without a cable. The WLAN has been introduced to alleviate difficulties in installment, maintenance, and relocation caused by cabling. With an increase in mobile users, the necessity for the WLAN is gradually increasing.

A WLAN includes an access point (AP), and a terminal The terminal may also be referred to as a station (STA). The AP refers to a device configured to transmit radio waves to enable WLAN users within a transmission distance to access the Internet and use a network. The AP acts as a base station for cellular phones or a hub of a wired network. A wireless high-speed Internet service provided by an Internet service provider (ISP) has an AP installed in a service area.

The terminal may be provided with a WLAN card to perform wireless network communication, and may include, for example, a personal computer (PC) including a laptop, a cellular phone, and a personal digital assistant (PDA).

The most widely used WLAN standard is an Institute of Electrical and Electronics Engineers (IEEE) 802.11 standard, which defines specifications on a media access control (MAC) and a physical layer constituting a WLAN.

A MAC layer defines rules and an order to be followed when a terminal or a device using a shared medium uses/accesses the medium, thereby enabling an efficient use of the capacity of the medium.

A basic constituent block of an IEEE 802.11 network is a basic service set (BSS). In the IEEE 802.11 network, there is an extended service set that extends a service area by connecting an independent network, for example, an independent BSS, to an infrastructure network, for example, an infrastructure BSS. In the independent network, terminals within the BSS may perform communication directly with each other. In the infrastructure network, an AP may be involved in communication performed between a terminal and another terminal existing inside or outside the BSS.

In general, an IEEE 802.11 based WLAN system may access a medium based on a carrier sense multiple access with collision avoidance (CSMA/CA) method, and each AP may operate separately therein. In the WLAN system, channels may not be assigned by a separate device. Each AP may separately select a channel based on an operator or channel assignment algorithm when the corresponding AP is powered on. Thus, in a case in which a number of WLANs are provided, overlapping channels may be likely to be used in each BSS. When channels overlap, interference may occur between adjacent BSSs.

When radio wave radiation devices not belonging to the same BSS radiate radio waves contrary to the rules at a short distance at which the radio wave radiation devices may have sufficient effects while WLAN communication devices belonging to the same BSS are performing communication pursuant to the rules, the WLAN communication devices may experience communication disruption.

In an existing interference environment WLAN network, a method of avoiding mutual interference using CSMA may be applied. However, in a CSMA protocol, an overall degree of freedom (DoF) of the network may be restricted to a number of AP antennas.

### SUMMARY

According to an aspect of the present invention, there is provided a method for opportunistic interference alignment (OIA), the method including broadcasting a random beam, receiving, from a terminal, feedback information determined based on the random beam, selecting at least one terminal to which data is to be transmitted from among terminals based on the feedback information, adjusting a transmission power based on the feedback information, and transmitting data to the selected at least one terminal based on the adjusted transmission power.

The method may further include transmitting a message indicating an initiation of multi-user multiple-input multiple-output (MU-MIMO) communication when terminals are selected for all subchannels or all streams.

According to another aspect of the present invention, there is also provided a method for OIA, the method including dividing the entire frequency band into a plurality of subchannels, broadcasting a random beam for each subchannel, receiving feedback information determined based on the random beam from a plurality of terminals, and selecting at least one terminal to which data is to be transmitted from among the terminals based on the feedback information for each subchannel.

According to still another aspect of the present invention, there is also provided a method for OIA, the method including generating feedback information based on a random beam when the random beam is received from an access point (AP), setting a waiting time based on a signal-to-interference-plus-noise ratio (SINR) included in the feedback information, and transmitting the generated feedback information to the AP when feedback information is not received from another terminal within a service range of the AP during the waiting time.

The method may further include resetting the waiting time as infinity when feedback information is received from the other terminal during the waiting time.

The method may further include resetting the waiting time as infinity when a message indicating that the AP received feedback information from at least one terminal is received from the AP during the waiting time.

According to yet another aspect of the present invention, there is also provided an AP including a communication unit to broadcast a random beam and receive feedback information determined based on the random beam from a terminal, a terminal selector to select at least one terminal to which data is to be transmitted based on the feedback information, and a transmission power adjuster to adjust a transmission power based on the feedback information.

The AP may further include a frequency band divider to divide the entire frequency band into a plurality of channels. The terminal selector may select at least one terminal to which data is to be transmitted from among the terminals based on the feedback information for each subchannel.

According to further another aspect of the present invention, there is also provided a terminal including a feedback information generator to generate feedback information based on a random beam when the random beam is received from an AP, a waiting time setter to set a waiting time based on an SINR included in the feedback information, and a communication unit to transmit the generated feedback information to the AP when feedback information is not received from another terminal within a service range of the AP during the waiting time.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an example of an interference environment of a wireless local area network (WLAN) according to an embodiment of the present invention;

FIG. 2 is a block diagram illustrating a configuration of an access point (AP) according to an embodiment of the present invention;

FIG. 3 is a block diagram illustrating a configuration of a terminal according to an embodiment of the present invention;

FIG. 4 is a diagram illustrating a range of channel use of Institute of Electrical and Electronics Engineers (IEEE) 802.11ac according to an embodiment of the present invention;

FIG. 5 is a flowchart illustrating a method for opportunistic interference alignment (OIA) according to an embodiment of the present invention;

FIG. 6 is a diagram illustrating a protocol of OIA according to an embodiment of the present invention;

FIG. 7 is a diagram illustrating a method of transmitting a clear to send (CTS) message including a feedback according to an embodiment of the present invention;

FIG. 8 is a flowchart illustrating a method for OIA performed by an AP according to an embodiment of the present invention;

FIG. 9 is a flowchart illustrating a method for OIA performed by a terminal according to an embodiment of the present invention;

FIG. 10 is a diagram illustrating a method of controlling a transmission power based on a signal-to-interference-plus-noise ratio (SINR) according to an embodiment of the present invention; and

FIG. 11 is a diagram illustrating a method of controlling a transmission power based on a leakage of interference (LIF) according to an embodiment of the present invention.

### DETAILED DESCRIPTION

Hereinafter, the preferred embodiments of the present invention will be described with reference to the accompanying drawings. It is to be understood that the detailed description, which will be disclosed along with the accompanying drawings, is intended to describe exemplary embodiments of the present invention, and is not intended to describe a unique embodiment through which the present invention can be carried out. The following detailed description includes detailed matters to provide full understanding of the present invention. However, it will be apparent to those skilled in the art that the present invention can be carried out without the detailed matters.

The following embodiments are proposed by combining constituent components and characteristics of the present invention according to a predetermined format. The individual constituent components or characteristics should be considered to be optional factors on the condition that there is no additional remark. If required, the individual constituent components or characteristics may not be combined with other components or characteristics. Also, some constituent components and/or characteristics may be combined to implement the embodiments of the present invention. The order of operations to be disclosed in the embodiments of the present invention may be changed to another. Some components or characteristics of any embodiment may also be included in other embodiments, or may be replaced with those of the other embodiments as necessary.

In the following description, specific terminologies used for embodiments of the present invention are provided to help the understanding of the present invention. And, the use of the specific terminology can be modified into another form within the scope of the technical idea of the present invention.

In some cases, to prevent ambiguity in the concept of the present invention, structures and apparatuses of the known art will be omitted, or will be shown in the form of a block diagram based on main functions of each structure and apparatus. Also, wherever possible, the same reference numbers will be used throughout the drawings and the specification to refer to the same or like parts.

Embodiments of the present invention are supportable by standard documents disclosed in at least one of wireless access systems including an IEEE 802 system, a third generation partnership project (3GPP) system, a 3GPP long term evolution (3GPP LTE) system, a long term evolution-advanced (LTE-A) system, and a third generation partnership project 2 (3GPP2) system. In particular, the steps or parts, which are not described to clearly reveal the technical idea of the present invention, in the embodiments of the present invention can be supported by the above documents. Moreover, all terminologies disclosed in this document can be supported by the above standard documents.

The following embodiments of the present invention can be applied to a variety of wireless access systems, for example, Code Division Multiple Access (CDMA), Frequency Division Multiple Access (FDMA), Time Division Multiple Access (TDMA), Orthogonal Frequency Division Multiple Access (OFDMA), Single Carrier Frequency Division Multiple Access (SC-FDMA), and the like. The CDMA may be implemented with radio technologies, for example, Universal Terrestrial Radio Access (UTRA) and CDMA2000. The TDMA may be implemented with radio technologies, for example, Global System for Mobile communications (GSM)/General Packet Radio Service (GPRS)/Enhanced Data Rates for GSM Evolution (EDGE). The OFDMA may be implemented with radio technologies, for example, IEEE 802.11 (Wi-Fi), IEEE 802.16 (WiMAX), IEEE 802-20, and Evolved UTRA (E-UTRA). For clarity, the following description focuses on the IEEE 802.11 system. However, technical features of the present invention are not limited thereto.

In a case of using interference alignment (IA) in a wireless local area network (WLAN), by mapping interference signals received at each receiving end in an interfering network to a space having a restricted dimension, an overall degree of freedom (DoF) of the network may increase in proportion to a number of access points (APs), and a sum-rate of the network environment may increase.

The IA may be implemented using various aspects of diversity. In the IA, an opportunistic interference alignment (OIA) method may increase an overall DoF of a network by providing a transmission opportunity to a terminal with most excellent IA, among a number of terminals, using multiuser diversity. The OIA refers to a method of aligning and transmitting signals to prevent an interference signal of a lower priority terminal from affecting a signal of a higher priority terminal In a case of the OIA, only a terminal with most excellent IA may need to be found. Thus, depending on a method of designing a protocol, the IA may be implemented using relatively modest feedback overhead.

Hereinafter, for ease of description, the followings may be assumed. However, the scope of the present invention should not be interpreted as being limited thereto.

(i) It may be assumed that the same channel is used for an uplink and a downlink between an AP and a terminal or a station (STA). It may be assumed that a channel reciprocity is provided.

(ii) It may be assumed that each terminal obtaining a transmission opportunity may receive a single symbol stream from an AP at the same time. A terminal may correspond to a user.

(iii) It may be assumed that a terminal may confirm information on a transmission vector space designated by an AP, and calculate an expected signal-to-interference-plus-noise ratio (SINR) based on the information on the transmission vector space. The terminal may calculate a leakage of interference (LIF) caused by interference from another AP or inter-user interference (IUI) in the same AP network. The transmission vector space may include information on a signal vector to be used by the AP for transmission. The LIF may indicate deep fades of channels among terminals. The AP may control a signal transmission power of a multi-user multiple-input multiple-output (MU-MIMO) system based on SINR information and LIF information of the terminal.

(iv) It may be assumed that each AP may receive all pieces of feedback information of a network to which the corresponding AP belongs and another interfering network since the pieces of feedback information are transmitted separately in an interfering network in terms of time.

(v) It may be assumed that a noise variance is estimated based on Equation 1.

E[n_{g,a}n_{g,a}^{H}]=I_{L×L} [Equation 1]

In Equation 1, n_{g,a} denotes a noise vector in a terminal a belonging to an AP network g. H denotes a channel matrix and E denotes a energy.

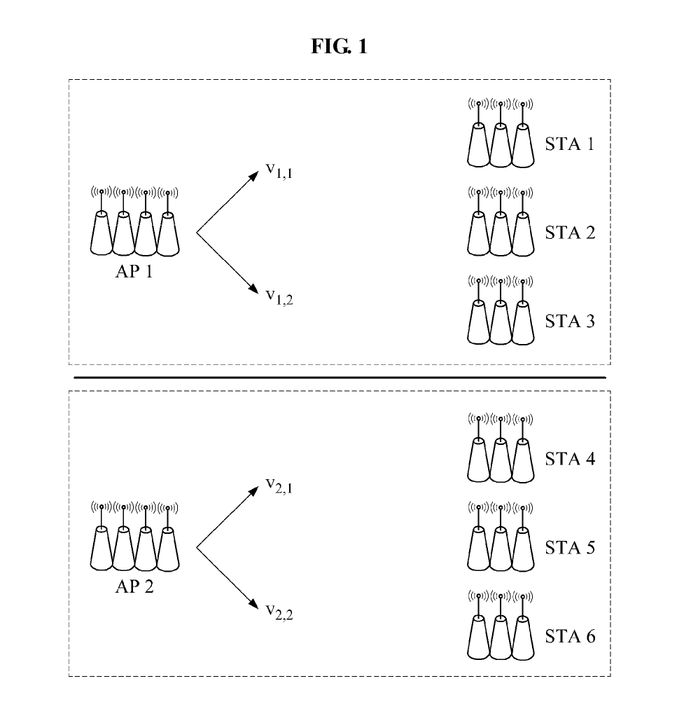

FIG. 1 is a diagram illustrating an example of an interference environment of a WLAN according to an embodiment of the present invention.

Referring to FIG. 1, a wireless transmission environment may include two APs. Each AP network may include three terminals, also referred to as a station (STA). Each AP may include four antennas, and each terminal may include three antennas.

Each AP may include multiple antennas, and each terminal may also include multiple antennas. In a WLAN, a number of terminals may access each AP network, and each terminal may receive a downlink message symbol through an AP in an AP network to which the corresponding terminal belongs.

Each terminal may use a plurality of antennas, for example, a multi-antenna, during a message symbol receiving process to reduce an effect of interference by another AP network. The terminal may reduce the effect of interference in a symbol decoding process using the plurality of antennas.

In a wireless interference channel environment, a plurality of terminals may transmit and receive signals to and from one another. In this example, a desired signal may be received along with an interference signal. In the wireless interference channel environment, when the AP transmits a signal to terminals in the AP network to which the AP belongs, the signal received by each terminal may be expressed by Equation 2.

$${r}_{g , {Φ}_{g} ( s )} = {H}_{g}^{g , {Φ}_{g} ( s )} {v}_{g , s} {s}_{g , {Φ}_{g} ( s )} + {\sum }_{l = 1 , l \neq s}^{s} {H}_{g}^{g , {Φ}_{g} ( s )} {v}_{g , l} {s}_{g , {Φ}_{g} ( l )} + {\sum }_{k \neq g}^{K} {\sum }_{l = 1}^{S} {H}_{k ,}^{g , {Φ}_{g} ( s )} {v}_{k , l} {s}_{k , {Φ}_{k} ( l )} + {n}_{g , {Φ}_{g} ( k )} , \qquad [ Equation 2 ]$$

In Equation 2, r_{g,1Φ}_{_{g}}₍ₛ₎ denotes a signal vector received by a terminal Φ_{g}(s) of an AP network g, Hₖ^{g,Φ}^{_{g}}^{(s)} denotes a wireless channel matrix between the terminal Φ_{g}(s) and an AP k, V_{g,s} denotes a transmission vector for an s-th symbol stream in the AP network g, and n_{g,Φ}_{_{g}}^{(s)} denotes white Gaussian noise in the terminal Φ_{g} (s) belonging to the AP network g. Φ_{g}(s) denotes a terminal obtaining a reception opportunity for the s-th symbol stream in the AP network g.

When message symbols are transmitted simultaneously by each AP network in an interference environment multiple AP network, an overall throughput of the network may decrease due to an interference phenomenon. Thus, to prevent the decrease in the throughput, appropriate interference coordination may be needed.

In a case of downlink MU-MIMO based interference coordination using OIA, each AP may select a terminal receiving most modest interference from another AP network, whereby the decrease in the throughput may be prevented. In OIA, a terminal may receive information on a transmission vector space from each AP, and determine an expected SNR level for each message symbol stream based on the received information on the transmission vector space. In this example, the expected SINR level for each symbol stream may be expressed by Equation 3.

$${SINR}_{g , a} ( s ) = \frac{{\vert {{w}_{g , a} ( s )}^{H} {H}_{g}^{g , a} {v}_{g , s , initial} \vert}^{2}}{{\vert {{w}_{g , a} ( s )}^{H} ( {\sum }_{l \neq s}^{S} {H}_{g}^{g , l} {v}_{g , l , initial} + {\sum }_{k = 1}^{K} {\sum }_{l = 1}^{S} {H}_{g}^{g , l} {v}_{k , l , initial} + {n}_{g , a} ) \vert}^{2}} \qquad [ Equation 3 ]$$

In Equation 3, SINR_{g,a}(s) denotes an SINR in a case in which an s-th message symbol stream is decoded by a terminal a belonging to an AP network g. w_{g,a}(s) denotes a reception vector to be used in a case in which a message is received through the s-th symbol stream in the terminal a of the AP network g. w_{g,a}(s) may be calculated by each terminal based on zero-forcing or a minimum mean square error (MMSE). n_{g,a} denotes a noise vector in the terminal a belonging to the AP network g, and Hₖ^{g,l} denotes a channel matrix between a terminal 1 belonging to the AP network g and an AP k. H_{g}^{g,l} denotes a channel matrix between the terminal 1 belonging to the AP network g and an AP g, and H_{g}^{g,a} denotes a channel matrix between the terminal a belonging to the AP network g and the AP g. V_{k,l,initial} denotes an initial vector to be transmitted to each terminal for an 1-th MU-MIMO transmission in an AP network k, V_{g,l,initial} denotes an initial vector to be transmitted to each terminal for an 1-th MU-MIMO transmission in the AP network g, and V_{g,s,initial} denotes an initial vector to be transmitted to each terminal for an s-th MU-MIMO transmission in the AP network g.

A power affected by an LIF in each terminal may be estimated based on Equation 4.

$${LIF}_{g , a} ( s ) = {\vert {{w}_{g , a} ( s )}^{H} ( {\sum }_{l \neq s}^{S} {H}_{g}^{g , l} {v}_{g , l , initial} + {\sum }_{k = 1}^{K} {\sum }_{l = 1}^{S} {H}_{k}^{g , l} {v}_{k , l , initial} ) \vert}^{2} \qquad [ Equation 4 ]$$

In Equation 4, LIF_{g,a}(s) denotes a residual power after interference from another AP network and IUI are decoded in a case in which an s-th symbol stream is decoded by a terminal a belonging to an AP network g. w_{g,a}(s) denotes a reception vector to be used in a case in which a message is received through the s-th symbol stream in the terminal a of the AP network g. Hₖ^{g,l} denotes a channel matrix between a terminal 1 belonging to the AP network g and an AP k, and H_{g}^{g,l} denotes a channel matrix between the terminal 1 belonging to the AP network g and an AP g. V_{k,l,initial} denotes an initial vector to be transmitted to each terminal for an 1-th MU-MIMO transmission in an AP network k, and V_{g,l,initial} denotes an initial vector to be transmitted to each terminal for an 1-th MU-MIMO transmission in the AP network g.

In an OIA based protocol, a terminal having a highest SINR may obtain an opportunity to receive a message symbol, whereby an effect of interference between AP networks may be minimized In this example, each AP may select a terminal based on SINR information of terminals, and control a power based on SINRs and LIFs. By controlling the power, an increased transmission efficiency may be achieved.

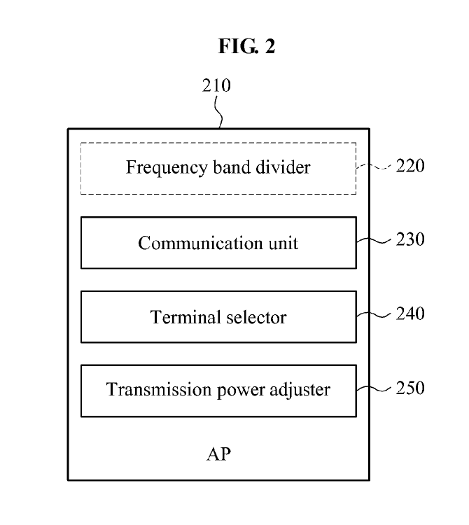

FIG. 2 is a block diagram illustrating a configuration of an AP 210 according to an embodiment of the present invention.

The AP 210 may increase a sum-rate using OIA in a MU-MIMO system in which a plurality of terminals interferes with one another. The AP 210 may broadcast a random beam, and opportunistically select a terminal to communicate with from among a plurality of terminals.

Referring to FIG. 2, the AP 210 may include a communication unit 230, a terminal selector 240, and a transmission power adjuster 250.

The communication unit 230 may broadcast a random beam. The communication unit 230 may select a transmission vector space at random, and broadcast information on the selected transmission vector space to the plurality of terminals. The communication unit 230 may generate orthogonal unit vectors at random, and broadcast the generated unit vectors to the plurality of terminals. The communication unit 230 may select and broadcast a set of predetermined orthogonal random beams.

The communication unit 230 may receive feedback information from a terminal The terminal may determine the feedback information based on the random beam received from the AP 210. The feedback information may include information on at least one of an

SINR and an LIF calculated by the terminal The LIF may include information on interference by another terminal within a service area of the AP 210 and information on interference by another AP.

When feedback information is received from the terminal, the communication unit 230 may transmit an acknowledgement (ACK) message indicating that the feedback information was received. The communication unit 230 may transmit an ACK message for a corresponding subchannel or stream after a clear to send (CTS) message related to the feedback message is received from the terminal

The terminal selector 240 may select at least one terminal to which data is to be transmitted from among the plurality of terminals based on the feedback information received from the terminal. The terminal selector 240 may select a terminal to which data is to be transmitted for each subchannel or each stream based on the feedback information.

The terminal selector 240 may select a terminal receiving most modest interference from another network. The terminal selector 240 may select at least one terminal to which data is to be transmitted from among the terminals based on SINR levels included in feedback information. For example, the terminal selector 240 may select a terminal having a highest level among SINRs of the terminals. The terminal selector 240 may select a first terminal that transmits a CTS message for each beam as the terminal to which data is to be transmitted. When a CTS message is received, the communication unit 230 may transmit an ACK message so that other terminals may not transmit CTS messages for the corresponding beam.

The transmission power adjuster 250 may adjust a transmission power based on the feedback information to increase a transmission efficiency. The transmission power adjuster 250 may adjust the transmission power based on at least one of the SINR and the LIF included in the feedback information.

In an embodiment, the transmission power adjuster 250 may adjust the transmission power based on an SINR received from a terminal The transmission power adjuster 250 may control the transmission power for each stream based on fairness of the SINRs of the terminals. The transmission power adjuster 250 may reduce the transmission power based on a lowest level among SINRs of the at least one terminal selected by the terminal selector 240.

In another embodiment, the transmission power adjuster 250 may adjust the transmission power based on an LIF level. The transmission power adjuster 250 may determine an average LIF level based on LIF levels of the plurality of terminals, and adjust the transmission power based on LIF levels of the at least one terminal selected by the terminal selector 240 and the determined average LIF level. The transmission power adjuster 250 may be aware of an interference effect in the entire network based on the LIF levels received from the terminals. The transmission power adjuster 250 may be aware of a relative effect of an LIF to be received by the terminals for each stream based on the average LIF level.

In still another embodiment, the transmission power adjuster 250 may adjust the transmission power based on both the SINR and the LIF. The transmission power adjuster 250 may adjust the transmission power based on a lowest level among the SINRs of the at least one terminal selected by the terminal selector 240 and the average LIF level determined based on the LIF levels of the terminals.

The communication unit 230 may broadcast information on the selected terminal The communication unit 230 may transmit data to the at least one terminal selected by the terminal selector 240 based on the transmission power adjusted by the transmission power adjuster 250. When a control message negotiation for the entire frequency band or streams is terminated, the communication unit 230 may broadcast information on the terminal selected by the terminal selector 240.

When terminals are selected for all subchannels or all streams, the communication unit 230 may transmit a message indicating an initiation of MU-MIMO communication. The communication unit 230 may include information on a terminal selected for each beam in the message indicating the initiation of MU-MIMO communication, and transmit the message.

In another embodiment, the AP 210 may further include a frequency band divider 220.

The frequency band divider 220 may divide the entire frequency band into a plurality of subchannels. The communication unit 230 may broadcast a random beam for each subchannel. The terminal selector 240 may select at least one terminal to which data is to be transmitted from among terminals based on feedback information for each subchannel.

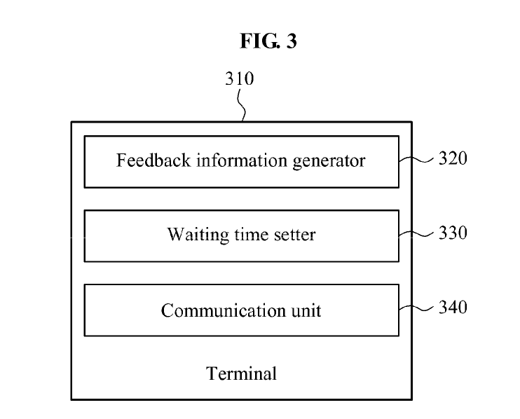

FIG. 3 is a block diagram illustrating a configuration of a terminal 310 according to an embodiment of the present invention.

Referring to FIG. 3, the terminal 310 may include a feedback information generator 320, a waiting time setter 330, and a communication unit 340.

The communication unit 340 may receive a random beam from an AP. The communication unit 340 may receive information on a transmission vector space or information on a predetermined orthogonal random beam from the AP.

The feedback information generator 320 may generate feedback information based on the random beam received from the AP. The feedback information generator 320 may determine an expected SINR for each stream. The feedback information generator 320 may determine an SINR based on the orthogonal random beam received from the AP.

The feedback information generator 320 may confirm the information on the transmission vector space designated by the AP, and determine the expected SINR based on the information on the transmission vector space. The feedback information generator 320 may determine expected SINRs for each message symbol stream based on information on transmission vector spaces received from all APs.

The feedback information generator 320 may determine an LIF caused by interference from another AP and interference from another terminal within a service range of the same AP. The feedback information generator 320 may determine a level of an LIF expected when signal decoding is performed. The feedback information generator 320 may generate the information on the SINR and the LIF as the feedback information.

The waiting time setter 330 may set a waiting time based on the SINR included in the feedback information. The waiting time setter 330 may set the waiting time to be inversely proportional to a level of the SINR.

In an embodiment, the waiting time setter 330 may reset the waiting time as infinity when feedback information is received from another terminal during the waiting time. In another embodiment, the waiting time setter 330 may reset the waiting time as infinity when a message indicating that the AP received feedback information from at least one terminal is received from the AP during the waiting time.

When an ACK message indicating that feedback information was received from the AP or a CTS message related to feedback information is received from another terminal included in the same network, the communication unit 340 may not transmit a CTS message for the corresponding subchannel to the AP during a transmission interval.

The terminal 310 may verify whether a transmission opportunity for each subchannel or each stream is obtainable through the received ACK message or CTS message. The terminal 310 may prevent flooding of a control message by not transmitting a CTS message to the AP with respect to a stream for which a negotiation is terminated.

The communication unit 340 may transmit the feedback information generated by the feedback information generator 320 to the AP when feedback information is not received from another terminal within a service range of the AP during the waiting time set by the waiting time setter 330. The communication unit 340 may transmit the CTS message and the feedback information to the AP. The communication unit 340 may transmit the feedback information for each subchannel or each stream. The communication unit 340 may classify and transmit the CTS message for each subchannel or each stream. The communication unit 340 may transmit an index of a beam, and information on an SINR and an LIF as the feedback information when transmitting the CTS message.

The AP may select a terminal to which data is to be transmitted based on the SINR information received from the terminal 310. The AP may adjust a transmission power based on the feedback information on the SINR and the LIF. The AP may transmit data to the selected terminal based on the adjusted transmission power.

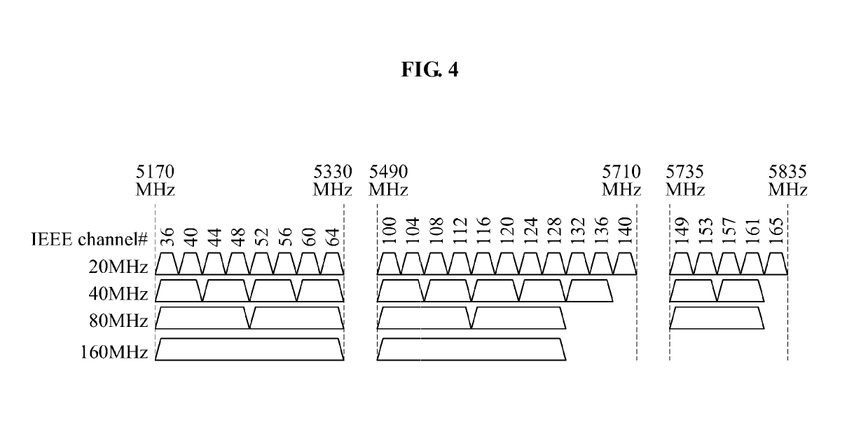

FIG. 4 is a diagram illustrating a range of channel use of IEEE 802.11ac according to an embodiment of the present invention.

In a case of IEEE 802.11ac, a bandwidth up to 160 megahertz (MHz) may be used. Due to the wide bandwidth, it may be inefficient for a single terminal to use all channels at the same time in terms of frequency selectivity. Thus, an AP may perform OIA coordination by dividing the entire frequency band into a number of subchannels. The OIA coordination performed by dividing the entire frequency band into the subchannels may have the following two advantages.

First, an effect of multiuser diversity may be achieved. In a case in which the entire frequency band is occupied and used by a single terminal, there may be, in general, a frequency interval where a deep fading effect occurs in a channel between the terminal and an AP communicating the terminal In the frequency interval where a deep fading effect occurs, it may be difficult to expect an improvement in the overall throughput due to a relatively low signal-to-interference-plus-noise ratio (SINR). In addition, the frequency interval where a deep fading effect occurs may cause a strong interference level in a predetermined frequency band, in an aspect of an interfering link. In this example, the throughput in a predetermined frequency band may decrease due to interference transferred from another network. In an implementation of an OIA protocol, when a bandwidth is divided into subchannels and a terminal is selected for each subchannel, a deep fading effect or a strong interference effect may be highly likely to be prevented based on a number of terminals, which leads to an increase in the overall throughput of the network.

Second, OIA coordination may be easily performed while communication of IEEE 802.11a is protected, in an aspect of backward compatibility. When the OIA coordination is performed by dividing the entire frequency band into a number of subchannels, the OIA coordination may be easily performed without any restriction in subchannels not being used by terminals of IEEE 802.11a.

In a subchannel where an existing IEEE 802.11a terminal performs communication, the existing IEEE 802.11a terminal and an IEEE 802.11ac terminal may coexist through an RTS-CTS exchange method and thus, an interference effect may be prevented.

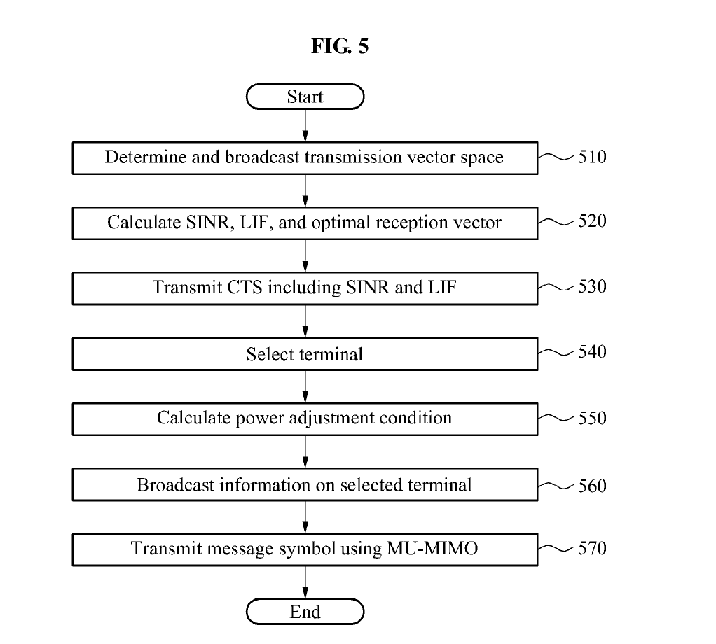

FIG. 5 is a flowchart illustrating a method for OIA according to an embodiment of the present invention. FIG. 5 illustrates a method for OIA in downlink (DL) MU-MIMO transmission.

Referring to FIG. 5, in operation 510, an AP may determine a transmission vector space at random, and broadcast the determined transmission vector space to terminals.

In operation 520, a terminal may calculate an expected SINR and an expected LIF for each stream, and calculate an optimal reception vector.

In operation 530, each terminal may transmit a CTS message including the SINR and the LIF to the AP. A waiting time for feedback may be determined by an inverse of the SINR.

In operation 540, the AP may receive CTS messages from the terminals, and select a terminal having an optimal performance based on SINRs. The AP may select a terminal having a highest SINR.

In operation 550, the AP may calculate a power adjustment condition based on at least one of the SINR and the LIF. The AP may adjust a power based on feedback information on the SINR and the LIF received from the terminal. By adjusting the power, a higher throughput when compared to a transmission power may be obtained.

In operation 560, the AP may broadcast information on the terminal selected in operation 540 to the terminal

In operation 570, the AP may transmit a message symbol to the terminal selected in operation 540 using MU-MIMO.

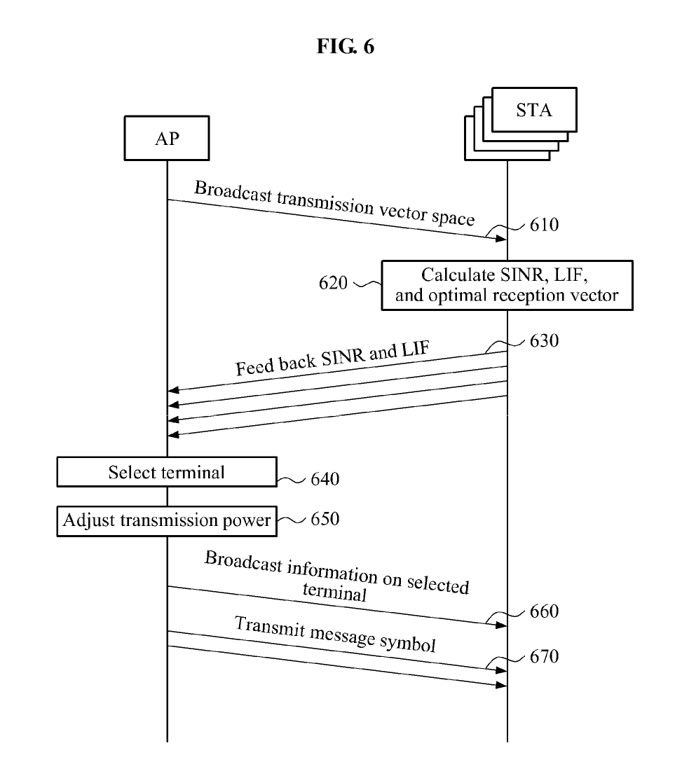

FIG. 6 is a diagram illustrating a protocol of OIA according to an embodiment of the present invention.

Referring to FIG. 6, in operation 610, an AP may broadcast a transmission vector space to terminals. The AP may designate a signal vector to be used by the AP for data transmission.

In operation 620, the terminals may calculate optimal reception vectors, and calculate SINRs and LIFs for each stream. The terminals may combine the reception vectors for each stream, and calculate an expected level of remaining interference.

In operation 630, the terminals may feed back the SINRs and the LIFs for each stream to the AP. A time during which a terminal waits to transmit a control message may be inversely proportional to a level of an SINR. For example, when SINR_{g,a}(f,s) denotes an SINR of a terminal a belonging to an AP network g for a subchannel f and a stream s, a waiting time after a system parameter is broadcast by the AP to transmit a CTS message including a feedback on the corresponding stream may be calculated by T,SINR_{g,a}(f,s)⁻¹. In this example, T_{c} denotes a preset constant. When other terminals belonging to the same network do not transmit feedbacks for the stream s during T_{c}SINR_{g,a}(f,s)⁻¹, the terminal a may transmit a feedback for the corresponding stream. In a case in which an ACK message or a CTS message for the corresponding subchannel and the stream is received from other terminals after a CTS message is received, the AP may not transmit a CTS message for the corresponding subchannel during a corresponding communication interval.

In operation 640, the AP may select a terminal based on the SINRs for each stream. The AP may select a terminal that may receive a data service for each subchannel and each symbol stream based on levels of the SINRs of the terminals.

In an interference coordination process using OIA, the AP may have only to identify a terminal having a lowest LIF level. Thus, a reception of LIF levels from all terminals may be unnecessary. In a control message negotiation process for data transmission, when a terminal having a highest SINR has a highest priority in CTS and feedback transmission, the terminal having the highest SINR may transmit a feedback most quickly. Thus, by disallowing other terminals to provide feedbacks for a stream after a single feedback for a single subchannel and the corresponding stream is transmitted, a feedback duration and an overhead may naturally decrease. The AP may reduce a control message overhead for OIA through CTS scheduling using SINR levels.

In operation 650, the AP may adjust a transmission power. The AP may control the transmission power based on levels of the SINRs and the LIFs. To assign a reception opportunity to a terminal for each subchannel and each stream, a CTS message may need to be transmitted for each subchannel and each stream. The AP may increase a throughput when compared to the transmission power by controlling the transmission power based on the levels of the SINRs and the LIFs, which leads to an increase in a battery lifespan of the terminal. In addition, a reduced transmission power may decrease an interference effect on another network for which interference coordination is yet to be performed.

In operation 660, the AP may broadcast information on the terminal selected in operation 640. When a control message negotiation for the entire frequency band and streams is terminated, the AP may broadcast information on the selected terminal for opportunistic transmission. Each terminal may receive a message symbol from the AP through a corresponding subchannel and stream.

In operation 670, the AP may transmit a message symbol to the terminal selected in operation 640 using MU-MIMO.

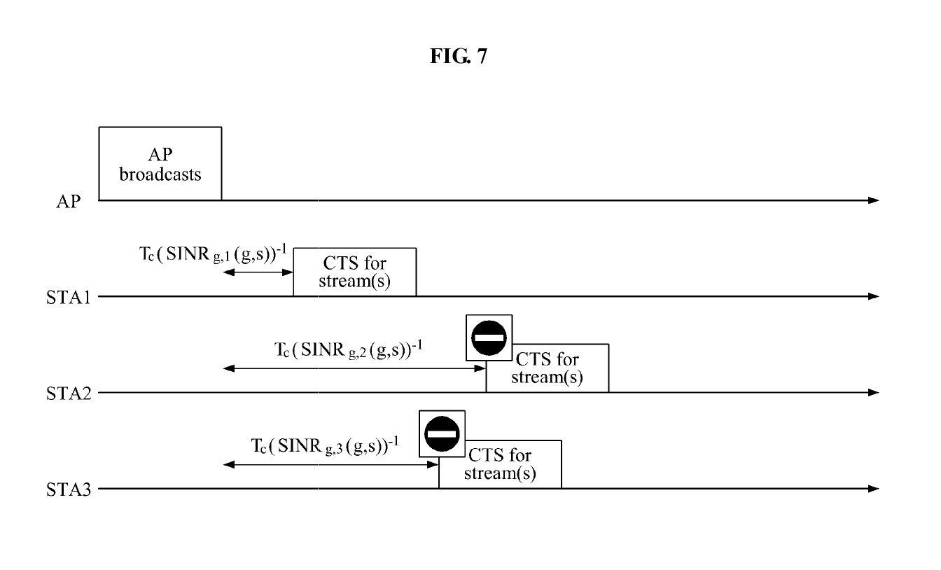

FIG. 7 is a diagram illustrating a method of transmitting a CTS message including a feedback according to an embodiment of the present invention.

FIG. 7 illustrates a method of transmitting a CTS message for each stream in a case in which a plurality of terminals or stations (STAs) is provided. Each STA may determine a waiting time to transmit a CTS message for each stream to have a common constant and to be inversely proportional to an initial SINR. When a single STA transmits a CTS message for a stream first, it may be deemed that the STA has a highest SINR, and that most excellent IA for transmission vector spaces determined by each AP is achieved. Thus, when a single STA transmits a CTS message for a single stream, other STAs in the same network may not additionally transmit CTS messages to the AP.

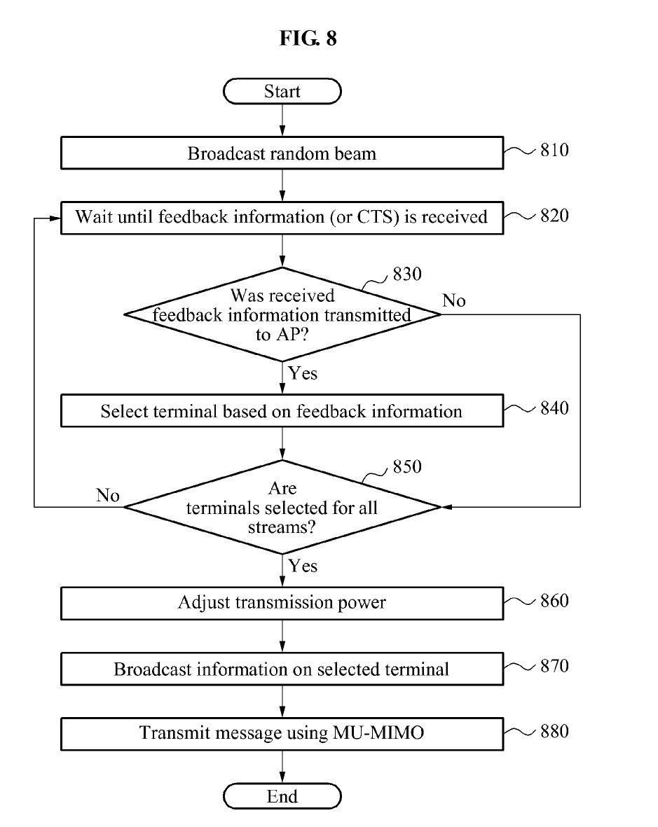

FIG. 8 is a flowchart illustrating a method for OIA performed by an AP according to an embodiment of the present invention.

Referring to FIG. 8, in operation 810, the AP may broadcast a random beam. The AP may select a transmission vector space at random, and broadcast the selected transmission vector space. The AP may generate orthogonal unit vectors at random, and broadcast the generated unit vectors to a plurality of terminals. The AP may broadcast, to the terminals, a vector space in which a message is transmitted at random. The AP may select and broadcast a set of predetermined orthogonal random beams.

In another embodiment, the AP may divide the entire frequency band into a plurality of subchannels before broadcasting the random beam. The AP may broadcast the random beam for each subchannel, and select a terminal for each subchannel.

In operation 820, the AP may wait until feedback information or CTS messages are received from terminals.

In operation 830, the AP may verify whether a received CTS message was transmitted to the AP. The AP may receive a CTS message including feedback information for each subchannel and each stream.

When the received CTS message was transmitted to the AP, the AP may select a terminal for opportunistic transmission, and transmit an ACK signal in operation 840. When feedback information is received from a terminal, the AP may transmit an ACK message indicating that the feedback information was received. The AP may select a terminal for each stream based on the feedback information received from the terminals. The AP may select a terminal to which data is to be transmitted for each subchannel or each stream based on the feedback information.

The AP may select a terminal receiving most modest interference from another network. The AP may select at least one terminal to which data is to be transmitted from among the terminals based on SINR levels included in the feedback information. For example, the AP may select a terminal having a highest level among SINRs of the terminals.

In operation 850, the AP may verify whether terminals are selected for all streams.

When terminals are selected for all streams, the AP may adjust a transmission power for each stream in operation 860. The AP may adjust the transmission power based on at least one of the SINR and the LIF included in the feedback information.

In an example, the AP may reduce the transmission power based on a lowest level among SINRs of at least one terminal selected by a terminal selector. In another example, the AP may determine an average LIF level based on LIF levels of the plurality of terminals, and adjust the transmission power based on the LIF levels of the at least one terminal selected by the terminal selector and the determined average LIF level. In another example, the AP may adjust the transmission power based on both the SINR and the LIF.

In operation 870, the AP may broadcast information on the selected terminal The AP may broadcast the information on the selected terminal after a control message negotiation phase is performed, thereby simultaneously informing the terminal that all control message negotiations are completed and that a communication phase is initiated. When terminals are selected for all subchannels or all streams, the AP may transmit a message indicating an initiation of MU-MIMO communication.

In operation 880, the AP may transmit a message using MU-MIMO. The AP may transmit data to the selected terminal based on the adjusted transmission power.

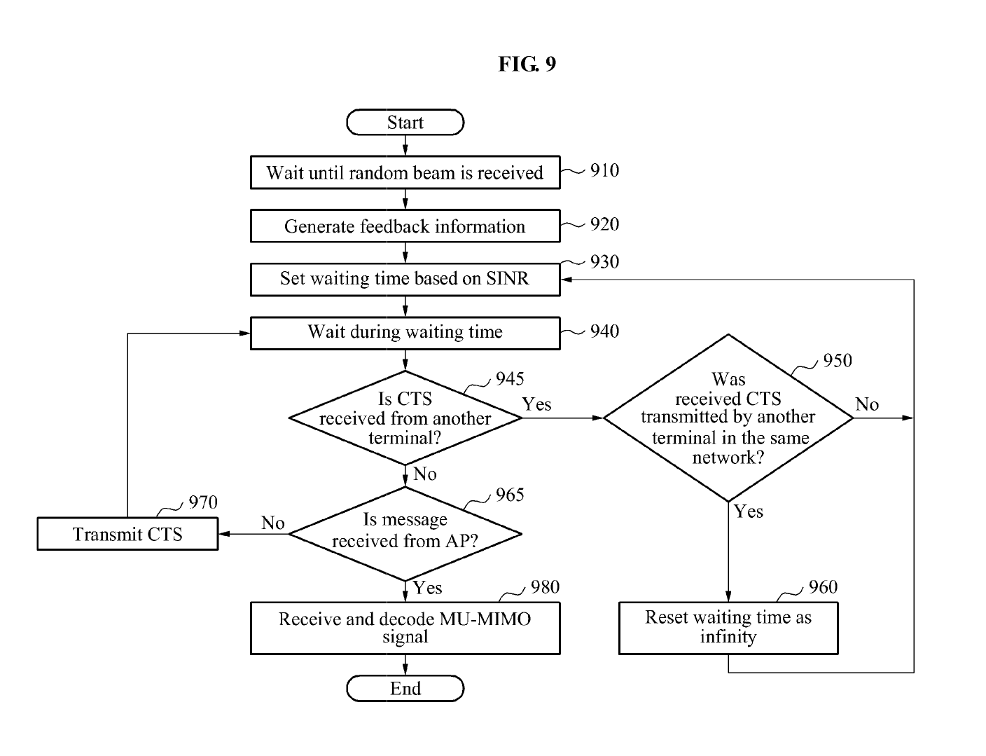

FIG. 9 is a flowchart illustrating a method for OIA performed by a terminal according to an embodiment of the present invention.

Referring to FIG. 9, in operation 910, the terminal may wait until a random beam is received from an AP. The terminal may wait until information on a transmission vector space designated by the AP or information on a predetermined orthogonal random beam is received from the AP.

In operation 920, the terminal may generate feedback information based on the received random beam. The terminal may calculate a waiting time, an SINR, and an LIF for each stream. The terminal may determine an expected SINR for each stream. For example, the terminal may determine the SINR based on the orthogonal random beam received from the AP.

The terminal may confirm the information on the transmission vector space designated by the AP, and determine the expected SINR based on the information on the transmission vector space. The terminal may determine expected SINRs for each message symbol stream based on information on transmission vector spaces received from all APs.

The terminal may determine an LIF caused by interference from another AP and interference from another terminal within a service range of the same AP. The terminal may determine a level of an LIF expected when signal decoding is performed. The terminal may generate the information on the SINR and the LIF as the feedback information.

In operation 930, the terminal may set a waiting time based on the SINR. The terminal may set the waiting time to be inversely proportional to a level of the SINR.

In operation 940, the terminal may wait during the waiting time for each stream.

In operation 945, the terminal may verify whether a CTS message related to the feedback information is received from another terminal

When a CTS message is received, the terminal may verify whether the received CTS message was transmitted to another terminal belonging to the same network in operation 950. The terminal may verify whether a transmission opportunity for each subchannel and each stream is obtainable through a CTS message of another terminal or an ACK message of the AP.

When the received CTS message was transmitted to another terminal belonging to the same network, the terminal may reset the waiting time for the corresponding stream as infinity in operation 960. The terminal may prevent flooding of a control message by not transmitting a CTS message for a stream for which a negotiation is terminated (setting the waiting time for the corresponding stream as infinity).

When it is verified in operation 945 that a CTS message is not received by the terminal, the terminal may verify whether a broadcast message is received from the AP in operation 965.

When a broadcast message is received from the AP, the terminal may receive a MU-MIMO signal from the AP and decode the received MU-MIMO signal in operation 980 in a case in which the received MU-MIMO signal was transmitted to the terminal

When it is verified in operation 965 that a broadcast message is not received from the AP, the terminal may transmit a CTS message for the corresponding subchannel to the AP in operation 970. The CTS message may include the feedback information determined by the terminal.

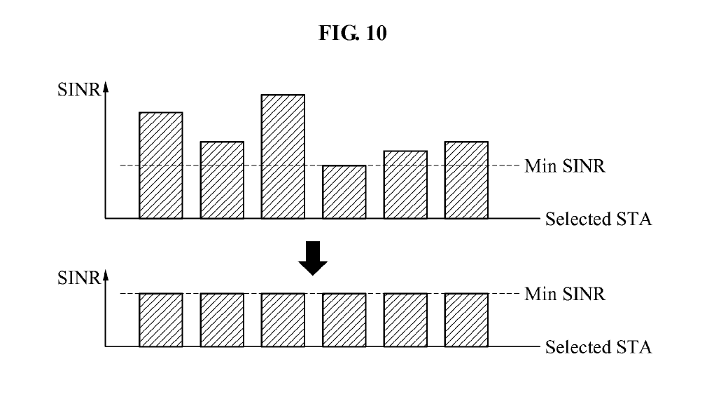

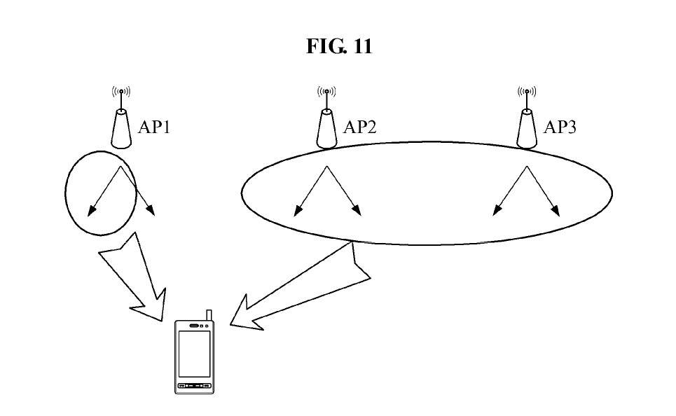

The AP may adjust a transmission power based on the restricted feedback information. The AP may adjust the transmission power based on SINR information of the terminals or information on a level of a residual LIF remaining after interference is eliminated by a terminal FIG. 10 illustrates a method of adjusting a transmission power based on SINR information of terminals by an AP, and FIG. 11 illustrates a method of adjusting a transmission power based on information a level of a residual LIF.

FIG. 10 is a diagram illustrating a method of controlling a transmission power based on an SINR according to an embodiment of the present invention.

In the SINR based transmission power control method, an AP may control a transmission power for each stream based on fairness degrees of SINRs of terminals. When terminals are selected by each AP for each stream, the selected terminals may have different SINR levels. When the power is adjusted based on the provided SINR levels, a higher throughput when compared to the transmission power may be obtained.

The selected terminals may have different SINR levels, and the transmission power for each terminal may be reduced based on a lowest level of the SINRs of the selected terminals to consider a fairness degree of the terminal

For example, the AP may adjust the transmission power based on Equation 5.

$${P}_{SINR} ( g , s ) = \frac{min {SINR}_{max} ( : , : )}{{SINR}_{max} ( g , s )} \qquad [ Equation 5 ]$$

In Equation 5, P_{SINR}(g,s) denotes an SINR based transmission power adjustment component determined for an s-th stream in an AP network g. minSINRₘₐₓ(:,:) denotes a lowest level among maximum SINR levels of selected terminals, and SINRₘₐₓ(g,s) denotes a maximum level of an SINR of a terminal selected for the s-th stream in the AP network g.

By reducing an amount of power to be transmitted to each terminal, a level of interference may decrease. Thus, terminals having relatively low SINRs may achieve greatly increased throughputs due to a reduced interference effect. Conversely, terminals having relatively high SINRs may achieve relatively reduced data rates due to the reduced amount of the transmission power. However, a general achievable throughput may be given by log(1+SINR), and a reduction in a data rate may decrease as a level of an SINR increases. A reduction in a data rate occurring in a terminal in a relatively high SINR area may decrease in comparison to an increase in a data rate occurring in a terminal in a relatively low SINR area. Thus, the overall throughput of the network may increase.

FIG. 11 is a diagram illustrating a method of controlling a transmission power based on an LIF according to an embodiment of the present invention.

In the LIF based transmission power control method, an AP may analyze an LIF of each terminal, and reduce a transmission power for a stream with a greatest interference effect based on a result of analyzing, thereby increasing an overall throughput.

FIG. 11 illustrates an interference effect of each terminal An effect of an LIF to be applied to each terminal may be expressed by Equation 6.

$${LIF}_{g , d , initial} ( s ) = {\sum }_{l = 1 , l \neq s}^{S} {\vert {w}_{d} ( s ) {H}_{g}^{g , d} {v}_{g} ( l ) \vert}^{2} + {\sum }_{k = 1 , k \neq g}^{K} {\sum }_{l = 1 , l \neq s}^{S} {\vert {w}_{d} ( s ) {H}_{k}^{g , d} {v}_{k} ( l ) \vert}^{2} \qquad [ Equation 6 ]$$

In Equation 6, H_{g}^{g,d} denotes a channel matrix between a terminal d belonging to an AP network g and an AP g, and Hₖ^{g,d} denotes a channel matrix between the terminal d belonging to the AP network g and an AP k. φ_{g}(s) denotes a terminal selected for a stream s in the AP network g.

Each terminal may calculate an LIF level to be assigned to the corresponding terminal based on Equation 6. Each terminal may include information on the calculated LIF level information, as feedback information, in a CTS message, and transmit the CTS message to the AP. The AP may identify an interference level in the entire network based on the received LIF level information. An average LIF level may be expressed by Equation 7.

$${LIF}_{total , avg } = {( KS - 1 )}^{- 1} {\sum }_{k = 1}^{K} {\sum }_{s = 1}^{S} {LIF}_{k , {φ}_{g} ( s ) , initial} ( s ) \qquad ( Equation 7 ]$$

In Equation 7, LIF_{total,org} denotes an average LIF level determined based on LIF levels of terminals in a network. K denotes a number of APs in the entire network, and S denotes a number of MU-MIMO streams per AP. φ_{g}(s) denotes a terminal selected for a stream s in an AP network g.

When the average LIF level is obtained, relative effects of an LIF to be applied to terminals for each stream may be calculated. The AP may adjust a power for each stream based on the relative effects of the LIF, as expressed by Equation 8.

$${P}_{l} ( s , g ) = min ( \frac{{LIF}_{g , {φ}_{g} ( s ) , initial}}{{LIF}_{total , avg}} , 1 ) \qquad [ Equation 8 ]$$

In Equation 8, Pᵢ(s,g) denotes an LIF based transmission power adjustment component determined for a stream s in an AP network g. LIF_{total,org} denotes an average LIF level determined based on LIF levels of terminals in a network.

In Equation 8, when an LIF level of a terminal is greater than an average level of LIFs of the entire network (an average LIF level), it may be deemed that the corresponding stream has relatively less interference with transmission of another stream. When the LIF level of the terminal is greater than the average level of the LIFs of the entire network, the AP may not decrease or perform a power reduction for the corresponding stream.

Conversely, when the LIF level of the terminal is less than the average level of the LIFs of the entire network, it may be deemed that the corresponding stream has relatively greatly effects on transmission of another stream. Thus, when the LIF level of the terminal is less than the average level of the LIFs of the entire network, the AP may adjust the balance of the overall interference effect by increasing a degree of the power reduction. The AP may adjust the transmission power based on the LIF level of the terminal, whereby a throughput of the network may increase.

The SINR based transmission power control method and the LIF based transmission power control method may be synthesized as expressed by Equation 9.

$$\begin{matrix}P ( g , s ) = {P}_{SINR} ( g , s ) {P}_{l} ( g , s ) {P}_{initial} \\ = \frac{min ( {SINR}_{max} ( : , : ) )}{{SINR}_{max} ( g , s )} ( min ( 1 , \frac{{LIF}_{g , {φ}_{g} ( s )} ( s )}{{LIF}_{total , avg}} ) ) {P}_{initial}\end{matrix} \qquad [ Equation 9 ]$$

In Equation 9, P(g,s) denotes a transmission power adjusted for a stream s in an AP network g, and Pᵢₙᵢₜᵢₐₗ denotes an original transmission power before the adjustment is performed. P_{SINR}(g,s) denotes an SINR based transmission power adjustment component determined for the s-th stream in the AP network g, and Pᵢ(g,s) denotes an LIF based transmission power adjustment component determined for the stream s in the AP network g. min SINRₘₐₓ(:.:) denotes a lowest level among maximum SINR levels of selected terminals, and SINRₘₐₓ(g,s) denotes a maximum SINR level of a terminal selected for the s-th stream in the AP network g. LIF_{total,avg} denotes an average LIF level determined based on LIF levels of the terminals in the network.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for opportunistic interference alignment (OIA) performed by an access point (AP), the method comprising:
broadcasting a random beam;
receiving, from a terminal, feedback information determined based on the random beam;
selecting at least one terminal to which data is to be transmitted from among terminals based on the feedback information;
adjusting a transmission power based on the feedback information; and
transmitting data to the selected at least one terminal based on the adjusted transmission power.

2. The method of claim 1, wherein the adjusting comprises adjusting the transmission power based on at least one of a signal-to-interference-plus-noise ratio (SINR) and a leakage of interference (LIF) included in the feedback information.

3. The method of claim 2, wherein the adjusting comprises reducing the transmission power based on a lowest level among SINRs of the selected at least one terminal.

4. The method of claim 2, wherein the adjusting comprises:
determining an average LIF level based on LIF levels of the terminals; and
adjusting the transmission power based on LIF levels of the selected at least one terminal and the average LIF level.

5. The method of claim 2, wherein the adjusting comprises adjusting the transmission power based on a lowest level among SINRs of the selected at least one terminal and an average LIF level determined based on LIF levels of the terminals.

6. The method of claim 1, wherein the selecting comprises selecting at least one terminal to which data is to be transmitted from among the terminals based on a level of the SNR included in the feedback information.

7. The method of claim 1, wherein the selecting comprises selecting a terminal to which data is to be transmitted for each subchannel or each stream based on the feedback information.

8. The method of claim 1, further comprising:
broadcasting information on the selected at least one terminal

9. The method of claim 1, wherein the broadcasting comprises:
selecting a transmission vector space at random; and
broadcasting information on the selected transmission vector space to a plurality of terminals.

10. The method of claim 1, further comprising:
transmitting an acknowledgement (ACK) message indicating that feedback information is received when the feedback information is received from a terminal

11. The method of claim 1, further comprising:
transmitting a message indicating an initiation of multi-user multiple-input multiple-output (MU-MIMO) communication when terminals are selected for all subchannels or all streams.

12. A method for opportunistic interference alignment (OIA) performed by a terminal, the method comprising:
generating feedback information based on a random beam when the random beam is received from an access point (AP);
setting a waiting time based on a signal-to-inference-plus-noise ratio (SINR) included in the feedback information; and
transmitting, to the AP, the generated feedback information when feedback information is not received from another terminal within a service range of the AP during the waiting time.

13. The method of claim 12, further comprising:
resetting the waiting time as infinity when feedback information is received from the other terminal during the waiting time.

14. The method of claim 12, further comprising:
resetting the waiting time as infinity when a message indicating that the AP received feedback information from at least one terminal is received from the AP during the waiting time.

15. The method of claim 12, wherein the setting comprises setting the waiting time to be inversely proportional to a level of the SINR.

16. The method of claim 12, wherein the AP adjusts a transmission power based on feedback information related to an SINR and a leakage of interference (LIF).

17. An access point (AP) comprising:
a communication unit to broadcast a random beam, and receive feedback information determined based on the random beam from a terminal;
a terminal selector to select at least one terminal to which data is to be transmitted from among terminals based on the feedback information; and
a transmission power adjuster to adjust a transmission power based on the feedback information.

18. The AP of claim 17, wherein the transmission power adjuster adjusts the transmission power based on at least one of a signal-to-interference-plus-noise ratio (SINR) and a leakage of interference (LIF) included in the feedback information.

19. The AP of claim 17, wherein the communication unit transmits data to the selected at least one terminal based on the adjusted transmission power.

20. The AP of claim 19, further comprising:
a frequency band divider to divide the entire frequency band into a plurality of subchannels,
wherein the terminal selector selects at least one terminal to which data is to be transmitted from among the terminals based on the feedback information for each of the subchannels.
